(19) United States
(12) Patent Application Publication
(10) Pub. No.: US 2012/0239462 A1
(43) Pub. Date: Sep. 20, 2012

(54) APPARATUSES AND METHODS FOR IMPROVING DRIVING PERFORMANCE

(75) Inventors: Jeffrey Pursell, Lindenhurst, IL (US); Nicholas Ehrhart, Wheeling, IL (US)

(73) Assignee: GREENDRIVER, INC., Northbrook, IL (US)

(21) Appl. No.: 13/176,470

(22) Filed: Jul. 5, 2011

Related U.S. Application Data
(60) Provisional application No. 61/453,997, filed on Mar. 18, 2011.

(51) Int. Cl. G06F 7/00; G06Q 10/00

(52) U.S. Cl. 705/7.38; 701/123

(57) ABSTRACT

Apparatuses and methods provide for improved driving performance. In one example, a method includes obtaining data describing vehicle parameters effecting fuel efficiency and carbon emissions, where the data is generated during operation of a vehicle by a driver. A performance rating for the driver may be generated based on the obtained data. The performance rating for the driver indicates how the driver's behavior impacted at least both the fuel efficiency and carbon emissions of the vehicle during operation of the vehicle by the driver. Related apparatuses are also disclosed.

### CROSS-REFERENCE TO RELATED APPLICATION

This application claims priority to the provisional patent application having Application No. 61/453,997, filed Mar. 18, 2011, having inventors Jeffrey Pursell et al., and owned by instant assignee, for “APPARATUSES AND METHODS FOR IMPROVING DRIVING PERFORMANCE” and is hereby incorporated by reference in its entirety.

### FIELD OF THE DISCLOSURE

The present disclosure relates to apparatuses and methods for improving driving performance.

### BACKGROUND OF THE DISCLOSURE

Persistent efforts have been made to improve upon vehicles' fuel efficiency and carbon emissions. For example, the inclusion of electric engines in vehicles constitutes one conventional technique for improving fuel efficiency and reducing the amount of carbon a vehicle emits. Similarly, and to a lesser degree, hybrid vehicles rely on both electric and combustion-based power sources in order to improve upon fuel efficiency and reduce CO₂ output. However, hybrid and electric cars are incapable of fulfilling the needs of many applications and markets. For example, cost, reliability, range, and other factors have prevented the commercial trucking industry from adopting hybrid or electrical vehicles as the industry standard.

Other conventional techniques and systems for improving vehicles' fuel efficiency and carbon emissions have adopted a similar approach to that of the electric and hybrid car; namely, improving/modifying the energy source in the vehicle itself to achieve increased fuel efficiency and carbon emissions. However, conventional techniques fail to account for the single greatest variable effecting a vehicle's fuel efficiency and carbon emissions: the driver. For example, the Environmental Protection Agency (EPA) estimates that up to 33% of a vehicle's fuel efficiency is impacted by driver behavior. Driver behavior can also have a serious impact on the amount of carbon that a vehicle emits.

Further still, some existing techniques and systems are aimed at determining and/or monitoring vehicles' fuel efficiency and carbon emissions based on diagnostic data obtained from the vehicles. Such systems frequently employ on-board reporting devices. On-board reporting devices generally include a microprocessor and may be connected to a vehicle's On-Board Diagnostic (OBD) system to receive data. The reporting devices also may include a transmitter for wirelessly transmitting processed data to a remote location (e.g., a remote server computer).

In one known system, a reporting device is used to collect data effecting a given vehicle's fuel efficiency. This data may include, for example, engine load data (LOAD), mass air flow data (MAF), etc. The collected data is then wireles sly transmitted to a remote computer system where it is used to calculate the vehicle of interest's fuel efficiency. In another known system, a reporting device is used to collect data effecting a given vehicle's carbon emissions. This data may include, for example, oxygen (O₂) gas content sensor data, air-flow rate, etc. The collected data is then wirelessly transmitted to a remote computer system where it is used to calculate the vehicle of interest's carbon emissions.

However, these systems merely report on the fuel efficiency and carbon emissions being achieved by vehicles. They provide scant information regarding a driver's impact on fuel efficiency and carbon emissions, and fail to identify areas where a driver may improve upon fuel efficiency and carbon emissions.

Accordingly, a need exists for apparatuses and methods capable of improving the behavior of drivers in order to improve the fuel efficiency and carbon emissions of those drivers' vehicles.

### BRIEF DESCRIPTION OF THE DRAWINGS

The disclosure will be more readily understood in view of the following description when accompanied by the below figures and wherein like reference numerals represent like elements, wherein:

FIG. 1 is a diagram generally depicting a system for improving driving performance in accordance with one example set forth in the present disclosure.

FIG. 2 is a block diagram generally depicting the system of FIG. 1 in greater detail in accordance with one example set forth in the present disclosure.

FIG. 3 illustrates an event summary that may be included on a scorecard in accordance with one example set forth in the present disclosure.

FIG. 4 illustrates a rating analysis and a peer rating that may be included on a scorecard in accordance with one example set forth in the present disclosure.

FIG. 5 illustrates a fleet performance rating that may be included on a scorecard in accordance with one example set forth in the present disclosure.

FIG. 6 illustrates an fleet specific acceleration summary which may be included on a scorecard in accordance with one example set forth in the present disclosure.

FIG. 7 illustrates a fleet specific deceleration summary which may be included on a scorecard in accordance with one example set forth in the present disclosure.

FIG. 8 is a flowchart illustrating one example of a method for improving driving performance.

FIG. 9 is a flowchart illustrating another example of a method for improving driving performance.

FIG. 10 is a flowchart illustrating yet another example of a method for improving driving performance.

### DETAILED DESCRIPTION OF THE PREFERRED EMBODIMENTS

The present disclosure provides methods and apparatuses for improving driver performance. In one example, a method includes obtaining data describing vehicle parameters effecting fuel efficiency and carbon emissions that are generated during operation of the vehicle by the driver. A performance rating for the driver is generated based on the obtained data describing vehicle parameters effecting fuel efficiency and carbon emissions. The performance rating for the driver indicates how the driver's behavior impacted the fuel efficiency and carbon emissions of the vehicle during operation of the vehicle by the driver.

In one example, the vehicle parameters effecting fuel efficiency and carbon emissions include: rate of acceleration, rate of deceleration, rate of change of engine revolutions-per-minute (RPM), vehicle over speed, and idle time. In another example, less than all five of the vehicle parameters effecting fuel efficiency and carbon emissions may be relied on in order to generate the performance rating. For example, in one embodiment, a performance rating for a given driver may be generated based on obtained data describing speed and idle time (or any other suitable combination of vehicle parameters as desired, e.g., rate of acceleration and RPM). In yet another example, the performance rating is generated such that an increase in performance rating indicates that the driver's behavior has improved the fuel efficiency and carbon emissions of the vehicle during operation of the vehicle by the driver over a period of time.

Among other advantages, the disclosed apparatuses and methods provide for the generation of a performance rating indicating how a driver's driving behavior impacts the fuel efficiency and carbon emissions of that driver's vehicle. By associating a performance rating with a particular driver, that driver's driving behavior may be tracked over time in order to identify inefficiencies in driving technique. The driver may then vary their technique in order to improve the fuel efficiency and carbon output of their vehicle. Other advantages will be recognized by those of ordinary skill in the art.

In one example, the method additionally includes accumulating multiple driver performance ratings, each of which indicates how the driver's driving behavior impacted both the fuel efficiency of the vehicle and the carbon emissions of the vehicle during operation of the vehicle by the driver over a period of time. A cumulative per-driver performance rating may be generated as a result. In another example, a peer rating is generated indicating the cumulative per-driver performance rating relative to a group rating. In this example, the group rating is based on a combination of cumulative per-driver performance ratings for each driver in a selected group of drivers. In yet another example, a fleet performance rating is generated indicating an overall performance of a fleet of drivers (including the driver that is the subject of the cumulative per-driver performance rating) over a period of time. In this example, the fleet performance rating is based on a combination of cumulative per-driver performance ratings for each driver in the fleet. In one example, a per-driver scorecard is generated that includes one or more of the cumulative per-driver performance rating, peer rating, and/or fleet performance rating.

The disclosure also provides a system for improving driving performance. In one example, the system includes a per-driver performance rating generator operative to obtain data describing vehicle parameters effecting fuel efficiency and carbon emissions that are generated during operation of the vehicle by the driver. In this example, the per-driver performance rating generator is also operative to generate a performance rating for the driver based on the obtained data, where the performance rating indicates how the driver's behavior impacted the fuel efficiency and carbon emissions of the vehicle during operation of the vehicle by the driver. In one example, the per-driver performance rating generator includes a processor and memory.

In another example, the system includes a reporting device operatively connected to the per-driver performance rating generator. In this example, the reporting device is operative to receive on-board diagnostic (OBD) data, such as OBD data from an OBD-II system in the vehicle. The reporting device is configured to generate data describing vehicle parameters effecting fuel efficiency and carbon emissions during operation of the vehicle based on the OBD data. Further, the reporting device is operative to wirelessly transmit the data describing vehicle parameters effecting fuel efficiency and carbon emissions to the per-driver performance rating generator over a suitable wireless network. The per-driver performance rating generator may use the data describing vehicle parameters effecting fuel efficiency and carbon emissions to generate the performance rating.

The disclosure also provides apparatuses for improving driving performance. In one example, an apparatus includes a per-driver performance rating generator operative to obtain data describing vehicle parameters effecting fuel efficiency and carbon emissions that are generated during operation of the vehicle by the driver and generate a performance rating for the driver based on the obtained data. In this example, the performance rating indicates how the driver's behavior impacted the fuel efficiency and carbon emissions of the vehicle during operation of the vehicle by the driver.

In another example, an apparatus includes a reporting device operative to receive OBD data or data from another source such as derived from a GPS system or other sources. The reporting device may generate data describing vehicle parameters effecting fuel efficiency and carbon emissions during operation of the vehicle by the driver based on the OBD data. The reporting is further operative to wirelessly transmit the data describing the vehicle parameters such that the data describing the vehicle parameters may be used to generate a performance rating for the driver. Again, the performance rating for the driver indicates how the driver's behavior impacted the fuel efficiency and carbon emissions of the driver's vehicle while under the operation of the driver.

In another example, an apparatus includes a reporting device operative to receive OBD data and determine values of vehicle parameters effecting both fuel efficiency and carbon emissions based on the OBD data. In this example, the reporting device is also configured to compare each determined vehicle parameter value with corresponding event generation criteria. The event generation criteria defines which, if any, event level of a plurality of event levels a particular determined vehicle parameter value corresponds to. Continuing with this example, the reporting device is further operative to generate an event having a particular level (e.g., level-one, level-two, etc.) in response to determining that the determined vehicle parameter value satisfies the corresponding event generation criteria. The event includes data describing the determined vehicle parameter value (e.g., data indicating that the vehicle accelerated at a particular rate). In one example, each event level corresponds to a range of vehicle parameter values. In another example determining the values of the vehicle parameters, the events and other data need not be based on OBD data. Instead the data may be generated based on GPS based information from a GPS system in the vehicle.

In another example, in addition to the determined vehicle parameter value, each generated event may also include associated data. Associated data may include, for example, a time at which the determined vehicle parameter value first satisfied the event generation criteria and/or a time at which the determined vehicle parameter value no longer satisfied the event generation criteria. Associated data may also include a duration that the determined vehicle parameter value satisfied the event generation criteria, a name of the determined vehicle parameter whose value satisfied the event generation criteria (e.g., “acceleration event”), a location of the vehicle when the determined vehicle parameter value first satisfied the event generation criteria (e.g., in longitudinal and latitudinal coordinates), and/or a date on which the determined vehicle parameter value first satisfied the event generation criteria.

In yet another example, the reporting device of the apparatus includes a transceiver operative to wirelessly transmit each generated event for use in generating a performance rating for the driver of the vehicle based in part on the particular level of each generated event. For example, weighting values may be assigned to each event based on the particular level of each event. In this manner, the weighted events may be combined to generate a performance rating (e.g., by the per-driver performance rating generator). In still another example, the reporting device includes a processor and memory.

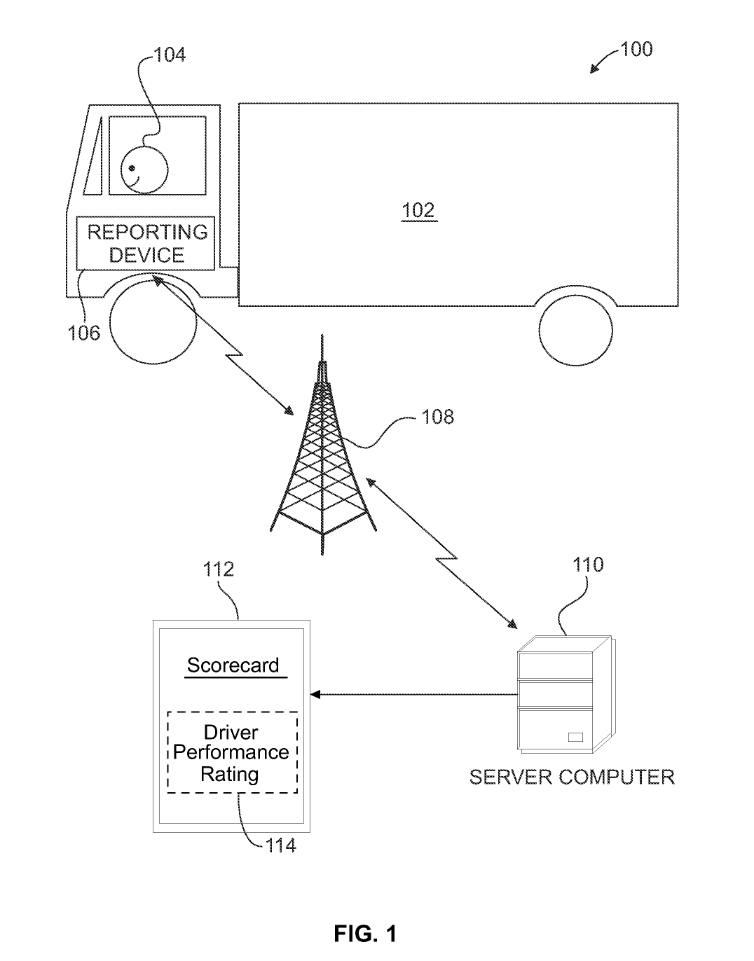

The following description of the embodiments is merely exemplary in nature and is in no way intended to limit the disclosure, its application, or uses. FIG. 1 illustrates one example of a system 100 for improving driving performance. The system includes a vehicle 102 having a driver 102 and a reporting device 106, a wireless communication channel 108, a server computer 110, and a scorecard 112 indicating a driver performance rating 114. The vehicle 102 may comprise any suitable vehicle having an OBD system such as, for example, a car or truck.

As will be discussed with greater specificity below, the reporting device 106 is operative to determine values of vehicle parameters effecting both fuel efficiency and carbon emissions during operation of the vehicle 102 by the driver 104. If the reporting device 106 concludes that one or more determined vehicle parameter values satisfy event generation criteria, it is operative to generate an event corresponding to the one or more vehicle parameter values that satisfy their corresponding event generation criteria. These generated events may be transmitted by the reporting device 106 over the wireless communication channel 108 to the server computer 110 for analysis. The wireless communication channel may comprise any suitable wireless communication channel known in the art including, but not limited to, a cellular network, a satellite network, or the internet. The server computer 110 may then analyze the transmitted event data in order to generate a driver performance rating 114 corresponding to the driver 104 of the vehicle 102. The driver performance rating 114 may be generated on a scorecard 112 in order to provide a visualization of the driver performance rating 114. The scorecard 112 may comprise, for example, a paper-based scorecard or an electronic scorecard (i.e., a scorecard that may be viewed electronically on, for example, a digital or analog display using techniques known in the art).

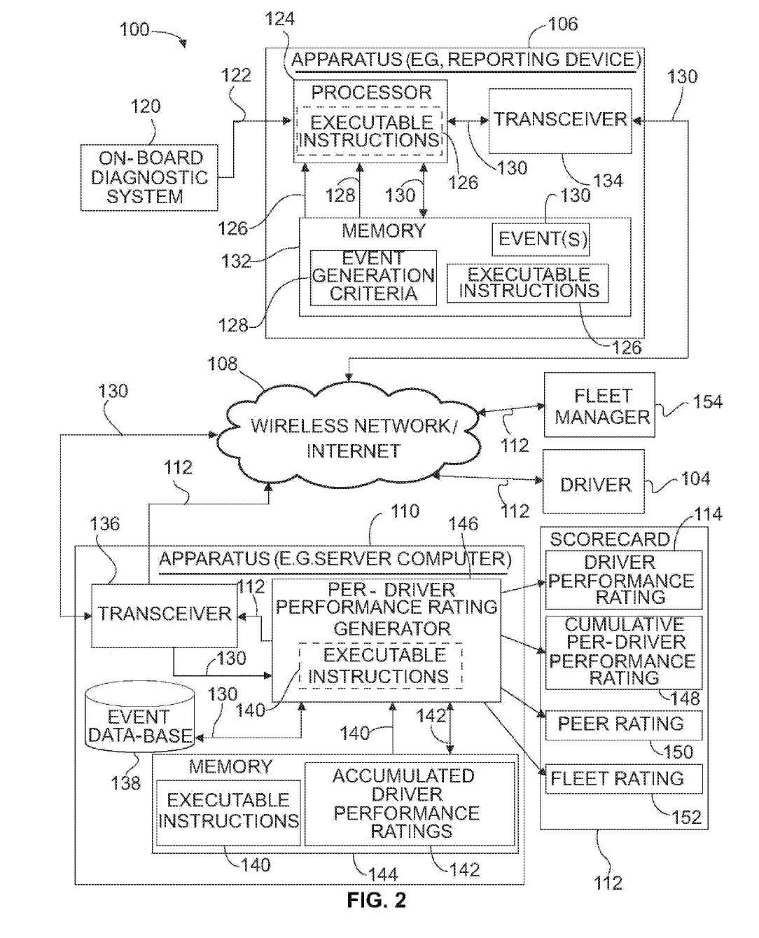

FIG. 2 illustrates the system 100 of FIG. 1 with the reporting device 106 and server computer 110 shown in greater detail. The reporting device 106 and on-board diagnostic system 120 are typically located on a vehicle, such as the vehicle 102 shown in FIG. 1. The reporting device 106 may comprise, for example, any suitable device known in the art capable of providing the functionality described herein. For example, the reporting device 106 may be implemented as a state machine, digital signal processor (DSP), a programmed processor with memory, etc. In one example, the reporting device 106 may comprise a telematics device such as the XT-2000-O device manufactured by Xirgo Technologies, LLC.

In the illustrated example, the reporting device 106 includes a processor 124 operatively connected to a transceiver 134 and memory 132. As used herein the processor 124 may include one or more processors (e.g., shared, dedicated, or group of processors such as but not limited to microprocessors, digital signal processors, or central processing units) and memory that execute one or more software or firmware programs. It is appreciated that the processor 124 could also be implemented as combinational logic circuit(s), an application specific integrated circuit, and/or other suitable components that provide the described functionality. The transceiver may comprise any suitable circuitry and/or logic capable of transmitting and receiving data such as, for example, a cellular or wireless internet modem. Memory 132 may comprise any combination of volatile/non-volatile memory components such as read-only memory (ROM), random access memory (RAM), dynamic random access memory DRAM, electrically erasable programmable read-only memory (EE-PROM), or any other suitable type of memory.

The reporting device 106 may be used to improve the driving performance of a driver 104 in the following manner. A driver 104 (or any other suitable personnel, e.g., a fleet manager, etc.) installs the reporting device 106 in the vehicle 102. In one example, the reporting device 106 plugs directly into the OBD connector (e.g., an OBD-II port) of the vehicle 102. That is, in this example, the reporting device 106 includes an interface configured to plug directly into the OBD connector without the need for any adaptors. This “plug-and-play” functionality is particularly useful for drivers who regularly change vehicles. That is, drivers who regularly change vehicles may merely remove the reporting device 106 from one vehicle and quickly and intuitively install it into another vehicle. In this manner, the reporting device 106 may be used to actively track a particular driver's behavior, rather than tracking the driving behavior of several drivers who happen to operate the same vehicle.

The reporting device 106 is activated upon ignition of the vehicle 102 by the driver 104. Following ignition, the reporting device 106 begins determining the values of vehicle parameters affecting fuel efficiency and carbon emissions. As used herein, emissions may include, for example, gaseous forms of hydrocarbons, oxides of nitrogen, carbon monoxide, or derivatives thereof. The vehicle parameters whose values are determined include, for example, rate of acceleration, rate of deceleration, rate of change of engine revolutions-per-minute (RPM), vehicle over speed, and idle time. However, it will be recognized that RPM need not be employed or that other values need not be used. These vehicle parameters may also be referred to as “driver behaviors,” as they are indicative of a driver's driving style (e.g., how rapidly a driver accelerates/decelerates, how long a driver travels at excessive speeds, how long a driver allows the vehicle 102 to idle, etc.). That is, the particular vehicle parameters that are considered are parameters that a driver 104 exercises a certain level of control over and that have an effect on both fuel efficiency and carbon emissions.

In one example, all five of the aforementioned vehicle parameters are relied upon in generating a performance rating for a driver. However fewer may also be used if desired. Generally speaking, a performance rating for a driver may be more reliable when it is based on obtained data describing all five of the aforementioned vehicle parameters effecting fuel efficiency and carbon emissions. However, it is recognized that in some embodiments, less than all five of the vehicle parameters may be relied upon. For example, in one embodiment, at least two of the aforementioned vehicle parameters are relied upon (e.g., speed and idle time). While relying upon less than all five of the vehicle parameters may reduce computational costs, it may also diminish the reliability of the performance rating that is generated.

The particular vehicle parameters considered by the reporting device 106 of the present system 100 differ from the parameters considered by conventional systems used to determine/monitor fuel efficiency and carbon emissions. For example, many conventional systems consider data provided by CO₂ sensors in order to determine carbon emissions of a vehicle. While such data may be useful in determining carbon emissions, it is not a parameter that a driver 104 may intuitively seek to improve upon when driving. Accordingly, the reporting device 106 of the present system 100 considers vehicle parameters (e.g., rate of acceleration) that: (1) effect both fuel efficiency and carbon emissions and (2) may be intuitively controlled by the driver 104.

Continuing with the exemplary system 100 set forth in FIG. 2, the processor 124 of the reporting device 106 performs the vehicle parameter value determinations based on OBD data 122 provided by the OBD system 120. The processor may receive the OBD data 122 over, for example, an OBD-II connector (e.g., a serial 16-cavity connector). As known in the art, OBD systems comprise a collection of microcontrollers and sensors that monitor a vehicle's 104 electrical, mechanical, and emissions systems. The OBD data 122 comprises raw data that does not directly provide the values of the vehicle parameters. Rather, the OBD data 122 may be used by the processor 124 to derive the values of the vehicle parameters. For example, the OBD data 122 may comprise vehicle speed data indicating the speed of a vehicle 102 at a particular moment. However, in order to determine values for the vehicle parameters acceleration/deceleration, for example, the processor 124 needs to compare vehicle speed values over a period of time. Accordingly, in one example, the processor 124 is operative to execute executable instructions 126 from memory 132 causing the processor 124 to compare vehicle speeds over time in order to determine the appropriate acceleration/deceleration values using techniques known in the art. The executable instructions 126 cause the processor to perform determinations for the other vehicle parameter values using similar techniques to that discussed above with respect to acceleration/deceleration. Although OBD data is described as being the source of the data, the data may be generated by the processor based on GPS information of the vehicle. For example, the speed can be generated from the GPS system based on location changes during a period of time. The rate of acceleration and other data could also be determined based on GPS data.

Following the determination of a vehicle parameter value, the processor 124 compares the determined vehicle parameter value with corresponding event generation criteria 128 in order to ascertain whether the determined vehicle parameter value warrants the generation of an event 130. An event 130 comprises data describing the determined vehicle parameter value, but may include additional information as well. For example, an event 130 may also include associated data that adds context to the event 130. This may include data indicating, for example, the time at which the determined vehicle parameter value first satisfied the event generation criteria 128, the time at which the determined vehicle parameter value no longer satisfied the event generation criteria 128, the duration that the determined vehicle parameter value satisfied the event generation criteria 128, the name of the determined vehicle parameter whose value satisfied the event generation criteria 128 (e.g., “idle”), and/or the location of the vehicle 102 when the determined vehicle parameter value first satisfied the event generation criteria 128. The location of the vehicle may be provided by a GPS component of the reporting device (not shown) in, for example, longitudinal and latitudinal coordinates. Associated data may also include the date on which the determined vehicle parameter value first satisfied the event generation criteria 128.

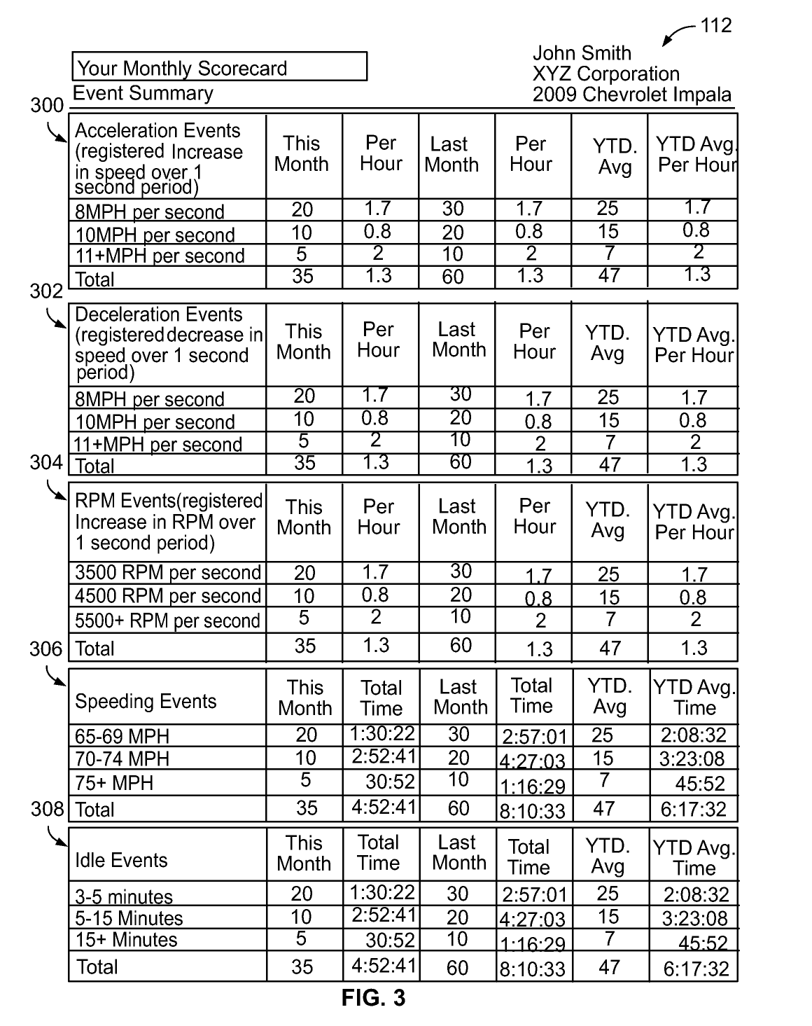

Events are better understood with brief reference to FIG. 3. FIG. 3 illustrates one example of an event summary for driver John Smith, an employee of XYZ Corporation who drives a 2009 Chevrolet Impala™. In this example, the summary is broken down in terms of the different event types, where each event type corresponds to a particular vehicle parameter whose value was determined by, for example, the processor 124 of the reporting device 106 in John's vehicle during operation. For example, table 300 corresponds to acceleration type events, table 302 corresponds to deceleration type events, table 304 corresponds to rate of change of RPM type events, table 306 corresponds to over speed/speeding type events, and table 308 corresponds to idle events.

Each table is further broken down into different levels of events that were generated while the vehicle 102 was under the operation of John. For example, acceleration events are depicted as being broken down into three levels. However, any suitable number of levels (e.g., 5 levels) may be used for each event type as desired. Categorizing events as having different levels allows for the application of weighting values during the generation of a driver performance rating (as discussed in detail below).

Continuing with table 300, the first level corresponds to a determination by the processor 124 of the reporting device 106 in John's vehicle that John's vehicle accelerated at a rate of 8 miles-per-hour (MPH) per second, but below 10 MPH per second at some point during operation. Thus, in order for the processor 124 in John's vehicle to generate a level-one event, the processor 124 must determine that the vehicle parameter “rate of acceleration” attained a value of at least 8 MPH per second (but less than 10 MPH per second) during operation of the vehicle by John. Similarly, in order for the processor 124 to generate a level-two event, the processor 124 must determine that vehicle accelerated at a rate of at least 10 MPH per second (but below 11 MPH per second). In order for the processor 124 to generate a level-three event, the processor 124 must determine that vehicle accelerated at a rate of at least 11 MPH per second. In this manner, each event level may correspond to a range of determined vehicle parameter values.

Event generation criteria 128 defines which, if any, event level of the plurality of event levels that a particular determined vehicle parameter value corresponds to. In this example, and with reference back to table 300, the event generation criteria 128 requires a determination that the vehicle parameter “rate of acceleration” reached 8 MPH per second at some point while the vehicle was being operated by John (i.e., the vehicle accelerated at a rate of at least 8 MPH over a one second period) in order for the processor 124 to generate an event 130 at all. That is, in this example, the event generation criteria 128 requires a threshold determination of a vehicle acceleration achieving or exceeding 8 MPH per second for any acceleration type event to be generated. If it is concluded that the determined vehicle parameter value satisfies this threshold for event generation, then the event generation criteria 128 further defines which particular level of event is generated. For example, the event generation criteria 128 defines a “rate of acceleration” vehicle parameter with a value of 10.5 MPH per second as corresponding to a level-two event in accordance with the conventions used in FIG. 3. Of course, it is recognized that the event levels (and thus, the event generation criteria 128) may be selected as desired. For example, the event generation criteria 128 may be predefined to permit the generation of a level-one acceleration event upon a determination that the vehicle 102 accelerated at a rate of 7 MPH per second during operation, rather than 8 MPH per second.

The concepts of event levels and event generation criteria apply equally to tables 302-308, with a few subtle distinctions. As with table 300, tables 302-308 illustrate that the other determined vehicle parameter values may correspond to one of three available event levels (although, as noted above, any suitable number of levels may be employed). Each table 300-308 includes columns labeled “This Month,” “Last Month,” and “YTD Avg.” (i.e., year-to-date average). The numbers in the rows of these columns represent the number of times that an event having a particular event level was generated during the appropriate time interval (defined by the column heading). For example, the number “20” under the column heading “This Month” in table 300 indicates that there were twenty level-one “rate of acceleration” type events that were generated this month while John was operating his vehicle. Similarly, the “Per Hour” column to the right of the “This Month” column summarizes the average number of events that were generated for each particular event level (and for each particular event type) over the current month. The “Last Month” column (and the “Per Hour” column to its right) convey the same information but with respect to the previous month. Finally, the “YTD Avg.” and “YTD Avg. Per Hour” columns summarize the average number of events that were generated for each particular event level (and for each particular event type) over the year, and over the year per-hour, respectively.

One noteworthy distinction between tables 300-304 and tables 306-308 is that tables 306-308 include time-based columns (e.g., “Total Time” for this and last month, and “YTD Avg. Time”). This is because, in addition to capturing each instance of an over speed/speeding type event and idle type event, tables 306-308 also capture data about how long each of those events lasted (i.e., the duration of those events). For example, and with regard to table 306, the cell located in the second row from the top and third column from the left notes that John spent 1:30:22 hours driving his vehicle between the speeds of 65-69 MPH (corresponding to a level-one over speed/speeding event) this month. Similarly, the corresponding row and column in table 308 indicates that John spent 1:30:22 hours allowing his vehicle to idle (corresponding to a level-one idle event) this month.

Returning back to FIG. 2, if the processor 124 determines that a determined vehicle parameter satisfies the corresponding event generation criteria 128 (as described above in detail with regard to FIG. 3), then it may generate an event 130 having a particular level (e.g., a level-one idle event). The event will include data describing the value of the determined vehicle parameter (e.g., data indicating that the rate of acceleration was calculated to be 10 MPH per second) along with any associated data. The generated event data 130 may be stored in memory 132 of the reporting device 106 until an appropriate time for transmission, which may be accomplished via the transceiver 134.

For example, over the course of a trip (e.g., from the time the driver turns the ignition on until the driver turns the ignition off), the processor 124 may generate a plurality of events 130. Each event 130 may be stored in memory 132 of the reporting device 106 until the end of the trip. At the end of a trip, the reporting device 106 is operative to wirelessly transmit the event data 130 over a suitable wireless network 108 using the transceiver 134. In one example, the event data 130 may comprise data packet(s) comprised of bits indicating the determined vehicle parameter values (and any associated data) corresponding to each generated event 130.

In one example, the event data 130 may be transmitted from the reporting device 106 at the end of each trip. However, in another example, event data 130 from a plurality of trips may be transmitted during a single transmission session. This type of batch-transmission is particularly useful when the reporting device 106 is out of the range of any suitable wireless network 108 at the end of a trip. In this situation, memory 132 may store the event data 130 corresponding to that trip until the end of a different trip, at which time communication over a suitable wireless network 108 may become available. Once communication over a suitable wireless network 108 becomes available, the reporting device 106 may transmit event data 130 corresponding to any number of (previously un-transmitted) trips during a single transmission session.

The event data 130 that is transmitted from the reporting device 106 over the wireless network 108 may be received by a transceiver 136 in an apparatus 110, such as a server computer, for analysis. While a server computer 110 is illustrated, it is recognized that any suitable computing device capable of performing the functionality described herein may be employed.

In any case, the server computer 110 obtains the event data 130 (i.e., data describing vehicle parameters effecting fuel efficiency and carbon emissions that was generated during the operation of the vehicle 102) via the transceiver 136. The transceiver 136 may comprise any suitable transceiver, such as one of the types of transceivers discussed above with respect to transceiver 134. In one example, the event data 130 is then transferred to an event database 138, for example, from the per-driver performance rating generator 146 via a suitable communication channel, such as a bus. The event database 138 may be implemented as any combination of volatile/non-volatile memory components including, but not limited to, read-only memory (ROM), random access memory (RAM), dynamic random access memory DRAM, electrically erasable programmable read-only memory (EE-PROM), or any other suitable storage medium, such as a database server. In this example, the event data 130 may remain stored in the event database 138 until such time as it is needed for use in generating a driver performance rating 114.

As desired, the per-driver performance rating generator 146 may obtain event data 130 from the event database 138 (or directly from the transceiver 136) for use in generating a per-driver performance rating 114. In one example, the per-driver performance rating generator includes a processor executing a database application as known in the art. In any case, the event data 130 may be transmitted to the per-driver performance rating generator 146 over a suitable communications channel such as a bus. In one example, the per-driver performance rating generator 146 may sample event data 130 for use in generating a driver performance rating once a month, although it is appreciated that the per-driver performance rating generator 146 may perform the sampling and driver performance rating 114 generation at any time, as desired. As used herein the per-driver performance rating generator 146 may include one or more processors (e.g., shared, dedicated, or group of processors such as but not limited to microprocessors, digital signal processors, or central processing units) and memory that execute one or more software or firmware programs. It is appreciated that the processor 124 could also be implemented as combinational logic circuit(s), an application specific integrated circuit, and/or other suitable components that provide the described functionality.

In one example, when the generation of a driver performance rating 114 is desired, the per-driver performance rating generator 146 is operative to execute executable instructions 140 from memory 144 causing the per-driver performance rating generator 146 to generate a performance rating 114 for the driver 102 that the event data 130 corresponds to. In one example, the executable instructions 140 cause the per-driver performance rating generator 146 to apply a mathematical model to the event data 130 in order to generate the driver performance rating 114.

The mathematical model may apply weighting values to certain events based on the particular level of those events. For example, the mathematical model may apply a heavier weight to level-three events than to level-one events. This is premised on an understanding that driver behavior corresponding to the generation of a level-three event will have a greater impact on the fuel efficiency and carbon emissions of that driver's vehicle than behavior corresponding to the generation of a level-one event. That is to say, the mathematical model recognizes that, for example, as the rate of acceleration increases, the fuel efficiency and carbon emissions of the vehicle suffer. Accordingly, the mathematical model may be generalized by stating that a driver responsible for the generation of primarily high level events (e.g., level-three events in each of the different event type categories) will typically receive a lower driver performance rating 114 than a driver responsible for the generation of primarily low level events (e.g., level-one events in each of the different event type categories).

In one example, the performance rating 114 may be generated by the per-driver performance rating generator 146 as follows. Initially, the event data 130 may be analyzed to determine the “Trip Hours” for a given trip. Trip Hours represent the sum of all “ignition on” hours excluding idle time (if any). The number of events for each particular vehicle parameter (i.e., driver behavior) and the level of each of those events may also be determined. For example, the total number of level-one acceleration events, level-two acceleration events, level-three acceleration events, etc., may be determined. This determination may be made for all of the different vehicle parameter events to determine the total “count” for all of the different event levels that were registered for each different vehicle parameter. A “count” represents the total number of instances of a particular level of event that were generated for a given trip. For example, on a given trip, it may be determined that there were four level-two acceleration events. Thus, the acceleration event level-two count would be four. A count is determined for each event level of each different vehicle parameter. That is, the total number of level-one events, level-two events, level-three events, level-four events, level-five events, etc. is determined for each respective vehicle parameter type (except for the vehicle parameters over speed and idle time, which are measured in units of time as set forth in the following discussion). For the vehicle parameters over speed and idle time, the duration that the vehicle operated within each particular event level is determined. For example, where the speed range 65-69 MPH corresponds to a level-one over speed event, the total amount of time that the driver operated the vehicle within the level-one over speed event range during the trip is determined.

Based on the count information describing the number of instances that each particular event level was reached for each particular vehicle parameter during a given trip and the duration information describing over speed time and idle time during the trip, the per-driver performance rating generator 146 may determine a “vehicle parameter event per hour raw score” for each vehicle parameter as follows. In one example, an acceleration event per hour raw score is determined based on the following equation:

Acceleration Event Per Hour Raw Score=((aw1*ac1)+(aw2*ac2)+(aw3*ac3)+(aw4*ac4)+(aw5*ac5))/th.

In the above equation, the variables represent the following information:

TABLE 1

| Variable | Meaning |
|---|---|
| aw1 | acceleration level 1 event weight (e.g., 1.00) |
| aw2 | acceleration level 2 event weight (e.g., 1.10) |
| aw3 | acceleration level 3 event weight (e.g., 1.25) |
| aw4 | acceleration level 4 event weight (e.g., 1.50) |
| aw5 | acceleration level 5 event weight (e.g., 2.00) |
| ac1 | acceleration level 1 event count |
| ac2 | acceleration level 2 event count |
| ac3 | acceleration level 3 event count |
| ac4 | acceleration level 4 event count |
| ac5 | acceleration level 5 event count |
| th | trip hours |

Thus, in the above example, five events levels are used. However, any suitable number of event levels may be considered as desired. Furthermore, in the above example, aw1-aw5 were assigned different weighting values. While particular weighting values were described (e.g., aw2 being set at 1.10), it is understood that any suitable weighting values may be used as desired. Based on the acceleration event per hour raw score, a normalized acceleration event per hour score may be determined, for example, by applying the following chart to the acceleration event per hour raw score:

TABLE 2

| Normalized | | |
|---|---|---|
| Acceleration | | Upper Limit of |
| Event Per | Lower Limit of Acceleration | Acceleration |
| Hour Score | Event Per Hour Raw Score | Event Per Hour Raw Score |
| 10 | 0.000 | 0.013 |
| 9 | 0.014 | 0.019 |
| 8 | 0.020 | 0.031 |
| 7 | 0.032 | 0.055 |
| 6 | 0.056 | 0.103 |
| 5 | 0.104 | 0.199 |
| 4 | 0.200 | 0.391 |
| 3 | 0.392 | 0.775 |
| 2 | 0.776 | 1.543 |
| 1 | 1.544 | 3.079 |
| 0 | 3.080 | No upper limit |

Of course, it is recognized that the lower limits and upper limits for each acceleration event per hour raw score may be selected as desired and do not necessarily have to correspond to the above example.

Similar to the acceleration event per hour raw score, the deceleration event per hour raw score may be determined using, for example, the following equation:

Deceleration Event Per Hour Raw Score=((dw1*dc1)+(dw2*dc2)+(dw3*dc3)+(dw4*dc4)+(dw5*dc5))/th.

In the above equation, the variables represent the following information:

TABLE 3

| Variable | Meaning |
|---|---|
| dw1 | deceleration level 1 event weight (e.g., 1.00) |
| dw2 | deceleration level 2 event weight (e.g., 1.10) |
| dw3 | deceleration level 3 event weight (e.g., 1.25) |
| dw4 | deceleration level 4 event weight (e.g., 1.50) |
| dw5 | deceleration level 5 event weight (e.g., 2.00) |
| dc1 | deceleration level 1 event count |
| dc2 | deceleration level 2 event count |
| dc3 | deceleration level 3 event count |
| dc4 | deceleration level 4 event count |
| dc5 | deceleration level 5 event count |
| th | trip hours |

Again, in the above example, five events levels are used. However, any suitable number of event levels may be considered as desired. Additionally, in the above example, dw1-dw5 were assigned different weighting values. While particular weighting values were described (e.g., aw2 being set at 1.10), it is understood that any suitable weighting values may be used as desired. Based on the deceleration event per hour raw score, a normalized deceleration event per hour score may be determined, for example, by applying the following chart to the deceleration event per hour raw score:

TABLE 4

| Normalized | | |
|---|---|---|
| Deceleration | | Upper Limit of |
| Event Per | Lower Limit of Deceleration | Deceleration |
| Hour Score | Event Per Hour Raw Score | Event Per Hour Raw Score |
| 10 | 0.000 | 0.015 |
| 9 | 0.016 | 0.045 |
| 8 | 0.046 | 0.095 |
| 7 | 0.096 | 0.176 |
| 6 | 0.177 | 0.311 |
| 5 | 0.312 | 0.533 |
| 4 | 0.534 | 0.900 |
| 3 | 0.901 | 1.506 |
| 2 | 1.507 | 2.504 |
| 1 | 2.505 | 4.153 |
| 0 | 4.154 | No upper limit |

Again, the lower and upper limits may be modified as desired.

Similar to the acceleration event per hour raw score and deceleration event per hour raw score, the RPM event per hour raw score may be determined using, for example, the following equation:

RPM Event Per Hour Raw Score=((rw1*rc1)+(rw2*rc2)+(rw3*rc3)+(rw4*rc4)+(rw5*rc5))/th.

In the above equation, the variables represent the following information:

TABLE 5

| Variable | Meaning |
|---|---|
| rw1 | RPM level 1 event weight (e.g., 1.00) |
| rw2 | RPM level 2 event weight (e.g., 1.10) |
| rw3 | RPM level 3 event weight (e.g., 1.25) |
| rw4 | RPM level 4 event weight (e.g., 1.50) |
| rw5 | RPM level 5 event weight (e.g., 2.00) |
| rc1 | RPM level 1 event count |
| rc2 | RPM level 2 event count |
| rc3 | RPM level 3 event count |
| rc4 | RPM level 4 event count |
| rc5 | RPM level 5 event count |
| th | trip hours |

As with the above discussions, any suitable number of event levels may be considered and the weighting applied to the different event levels may be selected as desired. Based on the RPM event per hour raw score, a normalized RPM event per hour score may be determined, for example, by applying the following chart to the RPM event per hour raw score:

TABLE 6

| Normalized | Lower Limit of | Upper Limit of |
|---|---|---|
| RPM Event | RPM Event | RPM Event |
| Per Hour Score | Per Hour Raw Score | Per Hour Raw Score |
| 10 | 0.000 | 0.026 |
| 9 | 0.027 | 0.038 |
| 8 | 0.039 | 0.063 |
| 7 | 0.064 | 0.116 |
| 6 | 0.117 | 0.227 |
| 5 | 0.228 | 0.461 |
| 4 | 0.462 | 0.951 |
| 3 | 0.952 | 1.980 |
| 2 | 1.981 | 4.141 |
| 1 | 4.142 | 8.680 |
| 0 | 8.681 | No upper limit |

Again, the lower and upper limits may be modified as desired. Also, RPM data need not be used.

The over speed event per hour raw score may be determined using, for example, the following equation:

Over Speed Event Per Hour Raw Score=((sw1*sd1)+(sw2*sd2)+(sw3*sd3)+(sw4*sd4)+(sw5*sd5))/th.

In the above equation, the variables represent the following information:

TABLE 7

| Variable | Meaning |
|---|---|
| sw1 | Over Speed level 1 event weight (e.g., 1.00) |
| sw2 | Over Speed level 2 event weight (e.g., 1.10) |
| sw3 | Over Speed level 3 event weight (e.g., 1.25) |
| sw4 | Over Speed level 4 event weight (e.g., 1.50) |
| sw5 | Over Speed level 5 event weight (e.g., 2.00) |
| sd1 | Over Speed level 1 duration |
| sd2 | Over Speed level 2 duration |
| sd3 | Over Speed level 3 duration |
| sd4 | Over Speed level 4 duration |
| sd5 | Over Speed level 5 duration |
| th | trip hours |

As with the above discussions, any suitable number of event levels may be considered and the weighting applied to the different event levels may be selected as desired. Based on the over speed event per hour raw score, a normalized over speed event per hour score may be determined, for example, by applying the following chart to the over speed event per hour raw score:

TABLE 8

| Normalized | Lower Limit of | |
|---|---|---|
| Over Speed Event | Over Speed Event | Upper Limit of Over Speed |
| Per Hour Score | Per Hour Raw Score | Event Per Hour Raw Score |
| 10 | 0.000 | 0.020 |
| 9 | 0.021 | 0.060 |
| 8 | 0.061 | 0.148 |
| 7 | 0.149 | 0.342 |
| 6 | 0.343 | 0.768 |
| 5 | 0.769 | 1.705 |
| 4 | 1.706 | 3.766 |
| 3 | 3.767 | 8.301 |
| 2 | 8.302 | 18.279 |
| 1 | 18.280 | 40.229 |
| 0 | 40.230 | No upper limit |

The lower and upper limits may be modified as desired.

In one example, the idle event per hour raw score may be determined using the following equation:

Idle Event Per Hour Raw Score=(id)/(th+id), where “id” represents the idle duration and “th” represents the trips hours.

Based on the idle event per hour raw score, a normalized idle event per hour score may be determined, for example, by applying the following chart to the idle event per hour raw score:

TABLE 9

| Normalized | | |
|---|---|---|
| Idle Event Per | Lower Limit of Idle Event | Upper Limit of Idle Event |
| Hour Score | Per Hour Raw Score | Per Hour Raw Score |
| 10 | 0.000 | 0.180 |
| 9 | 0.181 | 0.540 |
| 8 | 0.541 | 1.116 |
| 7 | 1.117 | 2.038 |
| 6 | 2.039 | 3.512 |
| 5 | 3.513 | 5.871 |
| 4 | 5.872 | 9.646 |
| 3 | 9.647 | 15.686 |
| 2 | 15.687 | 25.350 |
| 1 | 25.351 | 40.812 |
| 0 | 40.813 | No upper limit |

The lower and upper limits may be modified as desired.

Based on each of the vehicle parameter normalized event per hour scores, a driver performance rating 114 may be calculated for a given driver (representing that driver's performance over the month at issue) as follows. First, a “Green Rating” may be calculated based on four (acceleration, deceleration, RPM, and over speed) of the vehicle parameter normalized event per hour scores. The following equation is used to determine the “Green Rating”:

Green Rating=[(Normalized Acceleration Event Per Hour Score)*aw]+[(Normalized Deceleration Event Per Hour Score)*dw]+[(Normalized RPM Event Per Hour Score)*rw]+[(Normalized Over Speed Event Per Hour Score)*sw].

In the above Green Rating equation, the values aw, dw, rw, and sw, represent the acceleration weight, deceleration weight, RPM weight, and over speed weight, respectively. In one example, each weight takes the value of 0.25. However, it is recognized that the values for the weights may be selected as desired.

An “Idle Adjustment” is also calculated. In one example, the idle adjustment is determined based on the following equation:

Idle Adjustment=[8−(Normalized Idle Event Per Hour Score)]/3.

Then, in one example, the driver performance rating 114 may be determined based on the following equation:

Driver Performance Rating=Green Rating−Idle Adjustment.

Following the generation of a particular driver performance rating 114, that rating may be stored, for example, in memory 144 in order to provide for accumulated driver performance ratings 142. The accumulated driver performance ratings 142 may include multiple driver performance ratings 114 corresponding to multiple drivers. For example, the accumulated driver performance ratings 142 may include all of the individual driver performance ratings 114 attributable to “Driver A” and all of the individual driver performance ratings 114 attributable to “Driver B.” That is, the accumulated driver performance ratings 142 may include any number of individual driver performance ratings 114 attributable to any number of drivers.

In addition to generating a single driver performance rating 114 (that may, for example, merely correspond to a driver rating for single month), per-driver performance rating generator 146 is also operative to execute the executable instructions 140 causing it to generate a cumulative per-driver performance rating 148. The cumulative per-driver performance rating 148 generalizes (e.g., averages) all of the individual driver performance ratings 114 that have been generated for a single driver. In this manner, a driver 104 may continually monitor their cumulative per-driver performance rating 148 in order to track improvements (or regressions, as the case may be) in their driving behavior as it relates to fuel efficiency and carbon emissions.

The per-driver performance rating generator 146 is also operative to execute executable instructions 140 causing it to generate a peer rating 150. A peer rating 150 indicates a driver's cumulative per-driver performance rating 148 relative to a group rating. The group rating is based on a combination of cumulative per-driver performance ratings 114 for each driver in a selected group. For example, Driver A may be one of a plurality of drivers in a larger group (e.g., a fleet of drivers). Assuming that performance ratings 114 have been accumulated for each of the drivers in the group (so as to generate a cumulative per-driver performance rating 148 for each driver), the peer rating reflects an individual group member's rating(s) (i.e., driver performance rating 114 and/or cumulative per-driver performance rating 148) relative to the comparable rating(s) for the group (e.g., as calculated by averaging the cumulative per-driver performance ratings 148 of each driver in the group).

The per-driver performance rating generator 146 may also generate a fleet performance rating 152 indicating the overall performance of a fleet of drivers over a period of time. The fleet performance rating 152 may be based on a combination of cumulative per-driver performance ratings 148 for each driver in the fleet. Furthermore, the per-driver performance rating generator 146 is operative to generate a per-driver scorecard 112 including all of the various ratings 114, 148, 150, 152 previously discussed. Portions of an exemplary scorecard 112 are depicted in FIGS. 3-6 and discussed in further detail below.

The scorecard 112 may be generated in a tangible (e.g., paper-based) form or in electronic (e.g., digital or analog) form, as desired. For example, the scorecard 112 can be digital data (e.g., a digital file) or another generated data structure. The scorecard 112 may be stored, for example, in database entries, in a file (e.g., a Microsoft Word or Adobe .pdf file) accessible online as provided by a web server, etc.

In one embodiment, the per-driver performance rating generator 146 is operative to generate the scorecard 112 in electronic form for transmission via the transceiver 136 over the wireless network 108. In this example, the scorecard 112 may be reproduced visually (e.g., as pixel data) on a website hosted on the internet, for example, using techniques well-known in the art. In this manner, a driver 104 and/or a fleet manager 154 may access the hosting website to view the scorecard 112. However, it is recognized that the scorecard 112 could be provided to a driver 104 and/or manager 154 via alternate channels as well. For example, the scorecard 112 may be hand-delivered, mailed, emailed, faxed, texted, etc. to the driver 104 and/or manager 154 using data transmission techniques and protocols known in the art. That is, “generating a scorecard” may include, for example, sending an email with the scorecard as an attachment, uploading the scorecard to website, etc.

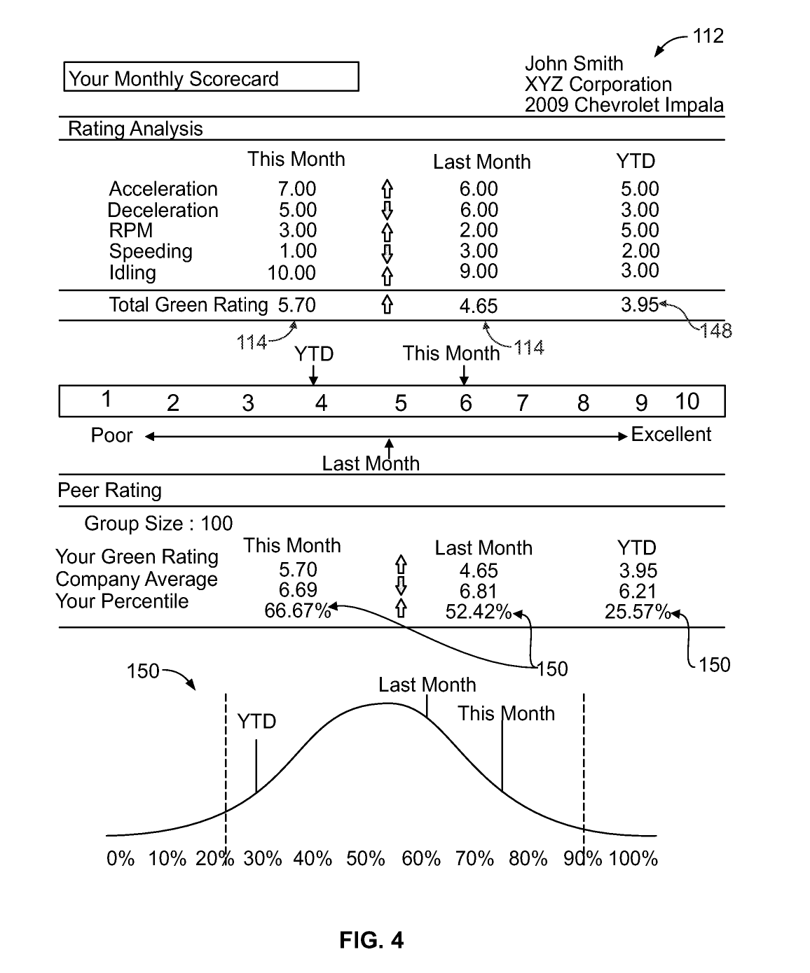

Referring now to FIG. 4, another page of an exemplary scorecard 112 for driver John Smith is illustrated. The top of the scorecard 112 provides a “Rating Analysis” portion that summarizes John's performance ratings on a per event-type basis for this month, last month, and year-to-date. Arrows are provided between the columns corresponding to “This Month” and “Last Month” in order to illustrate John's improvement (or regression) with respect to each event-type/driver behavior. The “Total Green Rating” row of the table provides John's driver performance rating 114 for the current month (5.70), his driver performance rating 114 for the previous month (4.65) and his cumulative per-driver performance rating 148 (3.95) for the year. The driver performance ratings for this month 114, last month 114, and the cumulative per-driver performance rating 148 are also visually depicted on a scale from 1-10. While a 1-10 scale is illustrated, it is appreciated that a color scale (e.g., where the color green corresponds to “excellent” whereas red corresponds to “poor”), an alphabetic scale (e.g., where the letter A corresponds to “excellent” whereas the letter F corresponds to “poor”), or any other suitable scale may be equally employed.

The bottom of the page of the scorecard 112 depicted in FIG. 4 provides a “Peer Rating” portion. In this portion, John's driver performance ratings for this month 114, last month 114, and his cumulative per-driver performance rating 148 are illustrated in relation to a generalized rating for the group of which John in a member (his company, in this case). In this manner, John may receive one or more peer ratings 150 that provide both a numerical and visual indication of where his driving behaviors effecting fuel efficiency and carbon emission stand relative to his peers (e.g., co-workers).

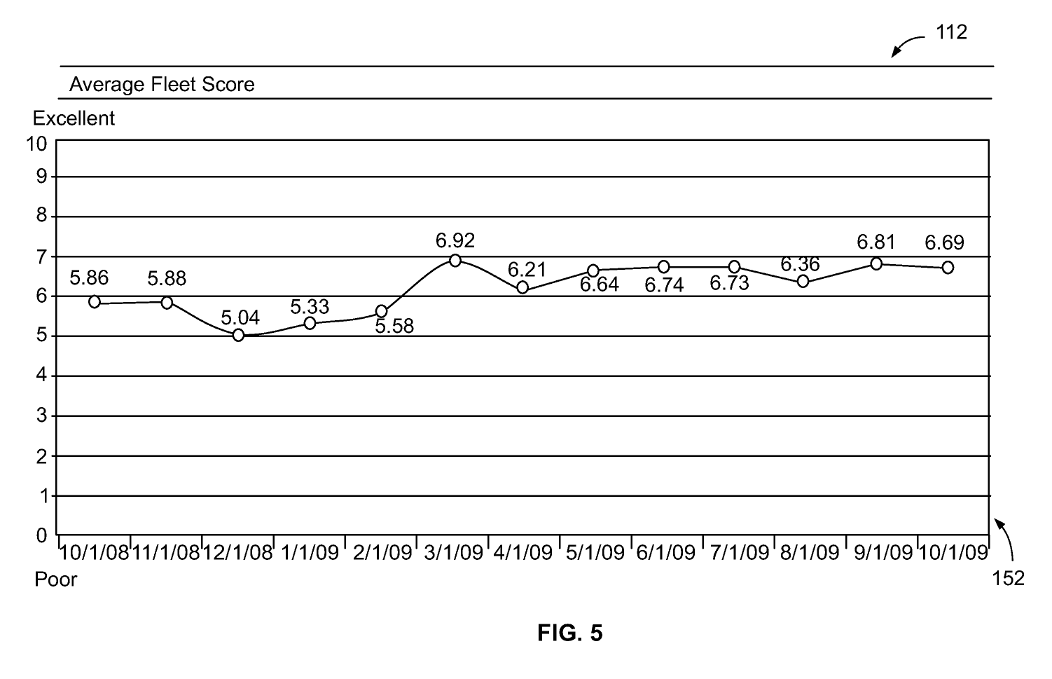

FIG. 5 illustrates a fleet performance rating 152, as described above, comprising an average of the cumulative per-driver performance ratings 148 for each driver in the fleet from Oct. 1, 2008 through Oct. 1, 2009. This visualization provides an intuitive way for a fleet manager 154 to track the fuel efficiency and carbon emissions of all of the vehicles in their fleet.

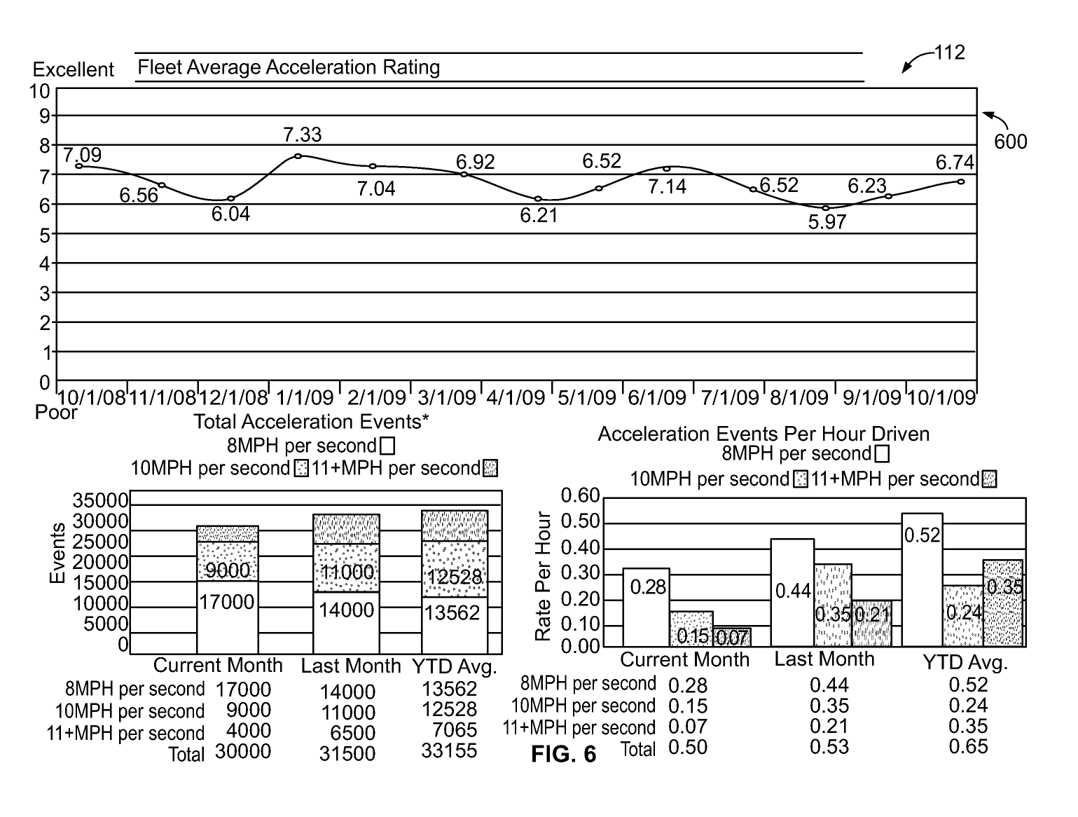

FIG. 6 illustrates the performance of a fleet in terms of the event type acceleration. For example, the acceleration summary 600 provides a graph depicting the average fleet acceleration rating comprising an average of the cumulative per-driver acceleration ratings for each driver in the fleet from Oct. 1, 2008 through Oct. 1, 2009. Acceleration summary also provides two bar graphs depicting (1) the total number of fleet acceleration events and (2) the average number of fleet acceleration events that are generated per hour driven.

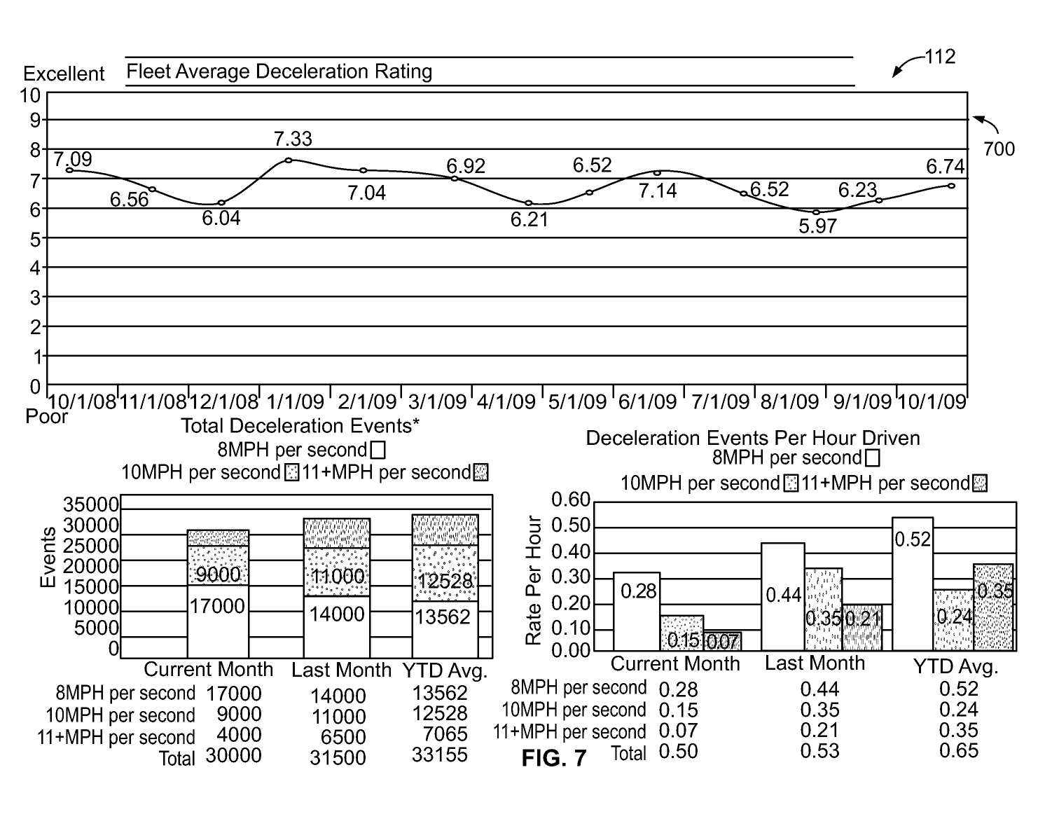

FIG. 7 illustrates the performance of a fleet in terms of the event type deceleration. The deceleration summary 700 provides similar data as that illustrated in FIG. 6, but with respect to the event type deceleration. Similar summaries may also be provided on the scorecard 112 for the other event types (e.g., rate of change of RPM, over speed/speeding, and/or idle time).

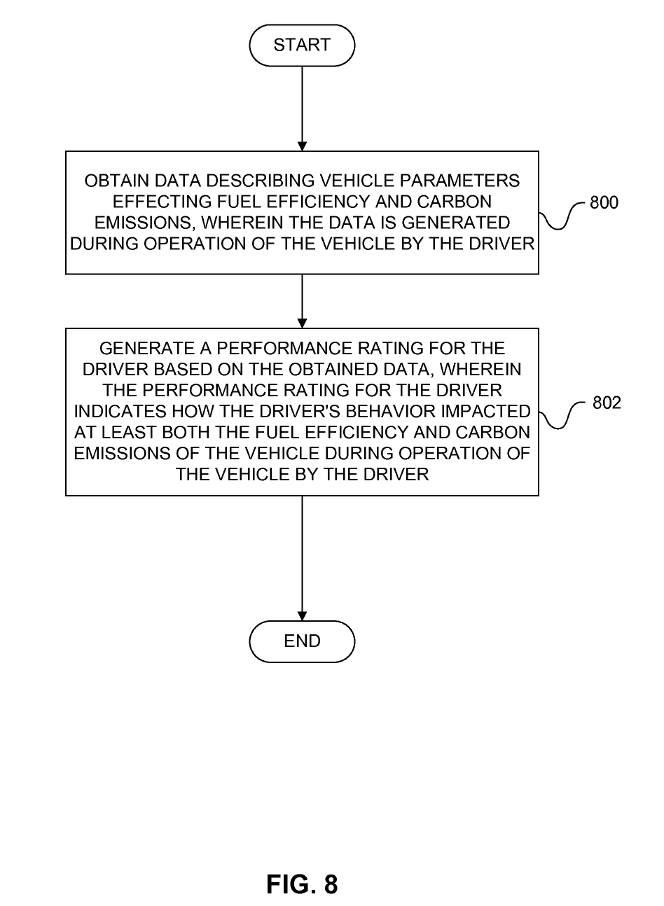

FIGS. 8-10 illustrate various methods for improving driving performance in accordance with the present disclosure. These methods may be achieved, for example, using the components of the system 100, in accordance with their above-described functionality. FIG. 8 illustrates one method for improving driving performance in accordance with the present disclosure. At step 800, data describing vehicle parameters effecting fuel efficiency and carbon emissions is obtained. The data is generated during operation of a vehicle by a driver. At step 802, a performance rating is generated for the driver based on the obtained data. The performance rating for the driver indicates how the driver's behavior impacted at least both the fuel efficiency and carbon emissions of the vehicle during operation of the vehicle by the driver.

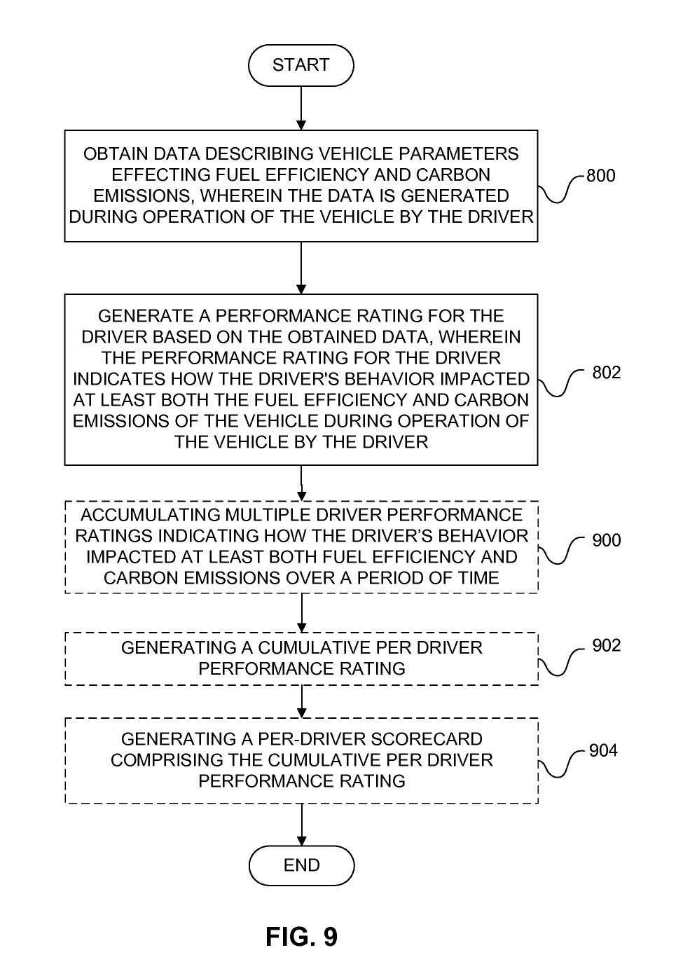

FIG. 9 illustrates another method for improving driving performance in accordance with the present disclosure. Steps 800-802 are carried out as discussed above with respect to FIG. 8. At step 900, multiple driver performance ratings are accumulated that indicate how the driver's behavior impacted at least both fuel efficiency and carbon emissions over a period of time. At step 902, a cumulative per-driver performance rating is generated. At step 904, a scorecard is generated that includes the cumulative per-driver performance rating.

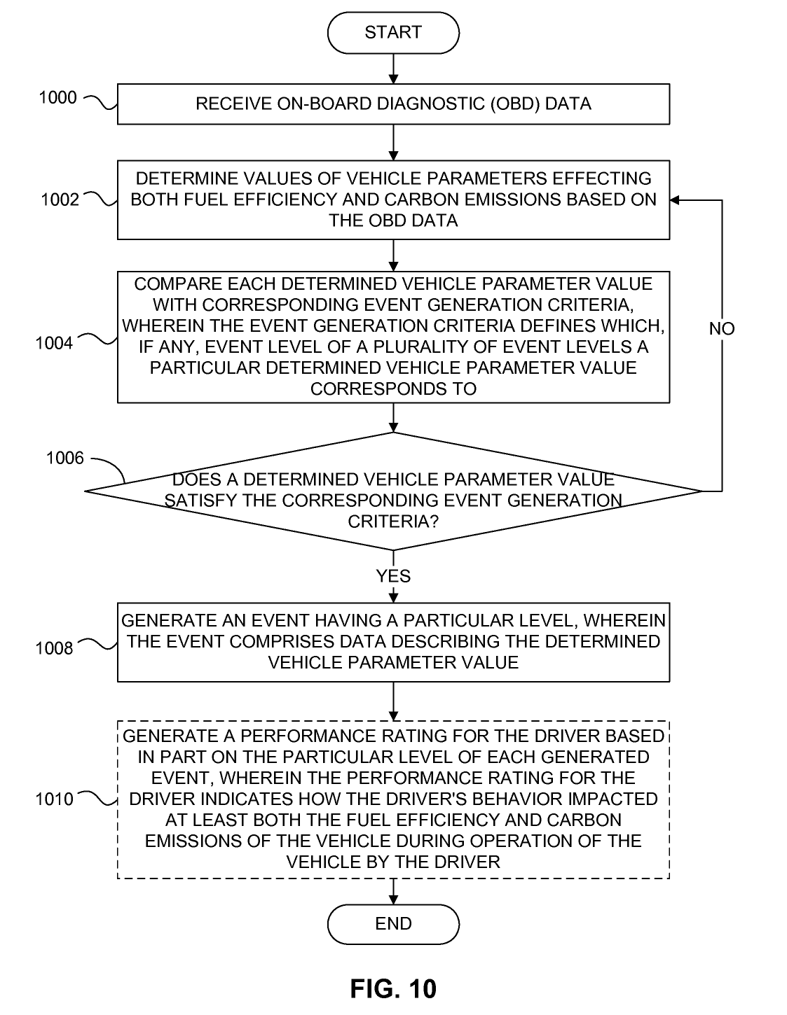

FIG. 10 illustrates yet another method for improving driving performance in accordance with the present disclosure. At step 1000, on-board diagnostic (OBD) data is received. At step 1002, values of vehicle parameters effecting fuel efficiency and carbon emissions are determined during operation of a vehicle by a driver. These vehicle parameters may include, for example, rate of acceleration, rate of deceleration, rate of change of RPM, vehicle over speed, and idle time. At step 1004, each determined vehicle parameter value is compared with corresponding event generation criteria that defines which, if any, event level of a plurality of event levels a particular determined vehicle parameter value corresponds to. At step 1006, a determination is made as to whether a determined vehicle parameter value satisfies the corresponding event generation criteria. If not, the method proceeds back to step 1002. However, when it is determined that a determined vehicle parameter value does satisfy the corresponding event generation criteria, the method proceeds to step 1008. At step 1008, an event having a particular level is generated, wherein the event includes data describing the determined vehicle parameter value. At optional step 1010, a performance rating is generated for the driver based in part on the particular level of each generated event. The performance rating for the driver again indicates how the driver's behavior impacted at least both the fuel efficiency and carbon emissions of the vehicle during operation of the vehicle by the driver.

Among other advantages, the disclosed apparatuses and methods provide for the generation of a performance rating indicating how a driver's driving behavior impacts the fuel efficiency and carbon emissions of that driver's vehicle. By associating a performance rating with a particular driver, that driver's driving behavior may be tracked over time in order to identify inefficiencies in driving technique. The driver may then vary their technique in order to improve the fuel efficiency and carbon output of their vehicle. Other advantages will be recognized by those of ordinary skill in the art.

The above detailed description and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

What is claimed is:

1. A method for improving driving performance, comprising:
obtaining data describing vehicle parameters effecting fuel efficiency and carbon emissions, wherein the data is generated during operation of a vehicle by a driver; and
generating a performance rating for the driver based on the obtained data, wherein the performance rating for the driver indicates how the driver's behavior impacted at least both the fuel efficiency and carbon emissions of the vehicle during operation of the vehicle by the driver.

2. The method of claim 1, further comprising:
accumulating multiple driver performance ratings indicating how the driver's behavior impacted at least both fuel efficiency and carbon emissions over a period of time; and
generating a cumulative per-driver performance rating.

3. The method of claim 2, further comprising:
generating a peer rating indicating the cumulative per-driver performance rating relative to a group rating, wherein the group rating is based on a combination of cumulative per-driver performance ratings for each driver of a plurality of drivers in a selected group.

4. The method of claim 3, further comprising:
generating a fleet performance rating indicating an overall performance rating for a fleet of drivers over a period of time, wherein the fleet performance rating is based on a combination of cumulative per-driver performance ratings for each driver in the fleet.

5. The method of claim 4, further comprising:
generating a per-driver scorecard comprising at least one of:
the cumulative per-driver performance rating;
the peer rating; and
the fleet performance rating.

6. The method of claim 1, wherein the vehicle parameters effecting fuel efficiency and carbon emissions comprise at least two of the following: rate of acceleration, rate of deceleration, rate of change of engine revolutions-per-minute (RPM), vehicle over speed, and idle time.

7. The method of claim 1, wherein the performance rating is generated such that an increase in performance rating indicates that the driver's behavior has improved at least both the fuel efficiency and carbon emissions of the vehicle during operation of the vehicle by the driver over a period of time.

8. A system for improving driving performance, comprising:
a per-driver performance rating generator operative to:
obtain data describing vehicle parameters effecting fuel efficiency and carbon emissions, wherein the data is generated during operation of a vehicle by a driver; and
generate a performance rating for the driver based on the obtained data, wherein the performance rating for the driver indicates how the driver's behavior impacted at least both the fuel efficiency and carbon emissions of the vehicle during operation of the vehicle by the driver.

9. The system of claim 8, further comprising:
a reporting device operatively connected to the per-driver performance rating generator, the reporting device operative to:
receive on-board diagnostic (OBD) data;
generate data describing vehicle parameters effecting fuel efficiency and carbon emissions based on the OBD data during operation of the vehicle by the driver; and
wirelessly transmit the data describing the vehicle parameters effecting fuel efficiency and carbon emissions to the per-driver performance rating generator.

10. The system of claim 8, wherein the per-driver performance rating generator is further operative to:
accumulate multiple driver performance ratings indicating how the driver's behavior impacted at least both fuel efficiency and carbon emissions over a period of time; and
generate a cumulative per-driver performance rating.

11. The system of claim 10, wherein the per-driver performance rating generator is further operative to:
generate a peer rating indicating the cumulative per-driver performance rating relative to a group rating, wherein the group rating is based on a combination of cumulative per-driver performance ratings for each driver of a plurality of drivers in a selected group.

12. The system of claim 11, wherein the per-driver performance rating generator is further operative to:
generate a fleet performance rating indicating an overall performance rating for a fleet of drivers over a period of time, wherein the fleet performance rating is based on a combination of cumulative per-driver performance ratings for each driver in the fleet.

13. The system of claim 12, wherein the per-driver performance rating generator is further operative to:
generate a per-driver scorecard comprising at least one of:
the cumulative per-driver performance rating;
the peer rating; and
the fleet performance rating.

14. The system of claim 8, wherein the vehicle parameters effecting fuel efficiency and carbon emissions comprise at least two of the following: rate of acceleration, rate of deceleration, rate of change of engine revolutions-per-minute (RPM), vehicle over speed, and idle time.

15. The system of claim 8, wherein the per-driver performance rating generator comprises a processor and memory.

16. An apparatus for improving driving performance comprising:
a per-driver performance rating generator operative to:
obtain data describing vehicle parameters effecting fuel efficiency and carbon emissions, wherein the data is generated during operation of a vehicle by a driver; and
generate a performance rating for the driver based on the obtained data, wherein the performance rating for the driver indicates how the driver's behavior impacted at least both the fuel efficiency and carbon emissions of the vehicle during operation of the vehicle by the driver.

17. The apparatus of claim 16, wherein the per-driver performance rating generator is further operative to:
accumulate multiple driver performance ratings indicating how the driver's behavior impacted at least both fuel efficiency and carbon emissions over a period of time; and
generate a cumulative per-driver performance rating.

18. The apparatus of claim 17, wherein the per-driver performance rating generator is further operative to:
generate a peer rating indicating the cumulative per-driver performance rating relative to a group rating, wherein the group rating is based on a combination of cumulative per-driver performance ratings for each driver of a plurality of drivers in a selected group.

19. The apparatus of claim 18, wherein the per-driver performance rating generator is further operative to:
generate a fleet performance rating indicating an overall performance rating for a fleet of drivers over a period of time, wherein the fleet performance rating is based on a combination of cumulative per-driver performance ratings for each driver in the fleet.

20. The apparatus of claim 19, wherein the per-driver performance rating generator is further operative to:
generate a per-driver scorecard comprising at least one of:
the cumulative per-driver performance rating;
the peer rating; and
the fleet performance rating.

21. The apparatus of claim 16, wherein the vehicle parameters effecting fuel efficiency and carbon emissions comprise at least two of the following: rate of acceleration, rate of deceleration, rate of change of engine revolutions-per-minute (RPM), vehicle over speed, and idle time.

22. The apparatus of claim 16, wherein the per-driver performance generator comprises a processor and memory.

23. An apparatus for improving the performance of a driver of a vehicle, comprising:
a reporting device operative to:
receive on-board diagnostic (OBD) data;
generate data describing vehicle parameters effecting fuel efficiency and carbon emissions based on the OBD data during operation of the vehicle by the driver; and
wirelessly transmit the data describing the vehicle parameters effecting fuel efficiency and carbon emissions, wherein the data describing vehicle parameters effecting fuel efficiency and carbon emissions may be used to generate a performance rating for the driver, and wherein the performance rating for the driver indicates how the driver's behavior impacted at least both the fuel efficiency and carbon emissions of the vehicle during operation of the vehicle by the driver.

24. The apparatus of claim 23, wherein the vehicle parameters effecting fuel efficiency and carbon emissions comprise at least two of the following: rate of acceleration, rate of deceleration, rate of change of engine revolutions-per-minute (RPM), vehicle over speed, and idle time.

25. The apparatus of claim 23, wherein the reporting device comprises a processor and memory.

26. A method for improving the performance of a driver of a vehicle, comprising:
receiving on-board diagnostic (OBD) data;
generating data describing vehicle parameters effecting fuel efficiency and carbon emissions based on the OBD data during operation of the vehicle by the driver; and
wirelessly transmitting the data describing the vehicle parameters effecting fuel efficiency and carbon emissions, wherein the data describing vehicle parameters effecting fuel efficiency and carbon emissions may be used to generate a performance rating for the driver, and wherein the performance rating for the driver indicates how the driver's behavior impacted at least both the fuel efficiency and carbon emissions of the vehicle during operation of the vehicle by the driver.

27. The method of claim 26, wherein the vehicle parameters effecting fuel efficiency and carbon emissions comprise at least two of the following: rate of acceleration, rate of deceleration, rate of change of engine revolutions-per-minute (RPM), vehicle over speed, and idle time.

28. An apparatus for improving the performance of a driver of a vehicle, comprising:
a reporting device operative to:
receive on-board diagnostic (OBD) data;
determine values of vehicle parameters effecting both fuel efficiency and carbon emissions based on the OBD data;
compare each determined vehicle parameter value with corresponding event generation criteria, wherein the event generation criteria defines which, if any, event level of a plurality of event levels a particular determined vehicle parameter value corresponds to; and
in response to determining that a determined vehicle parameter value satisfies the corresponding event generation criteria, generate an event having a particular level, wherein the event comprises data describing the determined vehicle parameter value.

29. The apparatus of claim 28, wherein each generated event further comprises associated data, the associated data including at least one of: a time at which the determined vehicle parameter value first satisfied the event generation criteria; a time at which the determined vehicle parameter value no longer satisfied the event generation criteria; a duration that the determined vehicle parameter value satisfied the event generation criteria; a name of the determined vehicle parameter whose value satisfied the event generation criteria; a location of the vehicle when the determined vehicle parameter value first satisfied the event generation criteria; and a date on which the determined vehicle parameter value first satisfied the event generation criteria.

30. The apparatus of claim 28, wherein each event level corresponds to a range of vehicle parameter values.

31. The apparatus of claim 28, wherein the reporting device further comprises:
a transceiver operative to wirelessly transmit each generated event for use in generating a performance rating for the driver of the vehicle based in part on the particular level of each generated event, wherein the performance rating for the driver indicates how the driver's behavior impacted at least both the fuel efficiency and carbon emissions of the vehicle during operation of the vehicle by the driver.

32. The apparatus of claim 28, wherein the vehicle parameters effecting fuel efficiency and carbon emissions comprise at least two of the following: rate of acceleration, rate of deceleration, rate of change of engine revolutions-per-minute (RPM), vehicle over speed, and idle time.

33. The apparatus of claim 28, wherein the reporting device comprises a processor and memory.

34. A method for improving the performance of a driver of a vehicle, comprising:
receiving on-board diagnostic (OBD) data;
determining values of vehicle parameters effecting both fuel efficiency and carbon emissions based on the OBD data;
comparing each determined vehicle parameter value with corresponding event generation criteria from memory, wherein the event generation criteria defines which, if any, event level of a plurality of event levels a particular determined vehicle parameter value corresponds to; and
in response to determining that a determined vehicle parameter value satisfies the corresponding event generation criteria, generating an event having a particular level, wherein the event comprises data describing the determined vehicle parameter value.

35. The method of claim 34, further comprising:
generating a performance rating for the driver based in part on the particular level of each generated event, wherein the performance rating for the driver indicates how the driver's behavior impacted at least both the fuel efficiency and carbon emissions of the vehicle during operation of the vehicle by the driver.

36. The method of claim 34, wherein generating the performance rating for the driver comprises assigning one of a plurality of weighting values to each event based on the particular level of each event and combining the weighted events to generate the performance rating.

37. The method of claim 34, wherein each generated event further comprises associated data, the associated data including at least one of: a time at which the determined vehicle parameter value first satisfied the event generation criteria; a time at which the determined vehicle parameter value no longer satisfied the event generation criteria; a duration that the determined vehicle parameter value satisfied the event generation criteria; a name of the determined vehicle parameter whose value satisfied the event generation criteria; a location of the vehicle when the determined vehicle parameter value first satisfied the event generation criteria; and a date on which the determined vehicle parameter value first satisfied the event generation criteria.

38. The method of claim 34, wherein each event level corresponds to a range of vehicle parameter values.

39. The method of claim 34, wherein the vehicle parameters effecting fuel efficiency and carbon emissions comprise at least two of the following: rate of acceleration, rate of deceleration, rate of change of engine revolutions-per-minute (RPM), vehicle over speed, and idle time.
